(19) United States
(12) Patent Application Publication
(10) Pub. No.: US 2009/0276404 A1
(43) Pub. Date: Nov. 5, 2009

(54) Method and system for efficient data structure for reporting on indeterminately deep hierarchies

(76) Inventor: Timothy J. Henigman, Huntington Beach, CA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/402,323

(22) Filed: Mar. 11, 2009

Related U.S. Application Data
(60) Provisional application No. 61/049,314, filed on Apr. 30, 2008.

(51) Int. Cl. G06F 17/30

(52) U.S. Cl. 707/3; 707/102; 707/E17.044; 707/E17.014

(57) ABSTRACT

A method, system, and medium related to a data structure having hierarchies based on a leaf node entity, the method including determining a reverse bridge table data structure for the hierarchical data, the reverse bridge table data structure including an association of all ancestor node entities of the hierarchical data for each leaf node entity of the hierarchical data and a hierarchical level for each association; determining an ordered listing of the associations of the ancestor node entities and each leaf node entity based on the hierarchical level for each association; and providing a hierarchy table data structure including an ordered aggregation of the hierarchical levels for each of the leaf node entities.

### CROSS-REFERENCE TO RELATED APPLICATION

This application claims the benefit of U.S. Provisional Patent Application Ser. No. 61/049,314, filed Apr. 30, 2008, entitled “EFFICIENT DATA STRUCTURE FOR REPORTING ON INDETERMINATELY DEEP HIERARCHIES” which is incorporated herein in its entirety.

### BACKGROUND

1. Field

Embodiments may generally relate to methods and systems of hierarchical data structures. More particularly, some embodiments are concerned with providing a data structure having a bottom-up representation of hierarchical data based on leaf nodes of the hierarchical data.

2. Description

Hierarchical data may be represented by a tree structure of nodes. Typically, the tree structure is presented according to a top down paradigm where a root node is located at an upper level and descendent nodes branch out from the root nodes with the branches terminating at leaf nodes. For certain reporting and querying purposes, including drill down processes, data associated with the various nodes must be included with the reporting and query results. In instances of predetermined or known depth hierarchies, the reporting of data associated with the specific nodes of the hierarchical data may be a fairly straight forward process. However, in an instance of reporting or performing a query on hierarchies of the hierarchical data at an indeterminate or otherwise unknown level, the gathering and reporting of the data associated with individual leaf nodes of the tree structure may be inefficient and cumbersome, requiring complex procedural processes.

As such, there exists a need for a system, method, and computer executable program that facilitates efficient provisioning, creation, and building of a bottom up data structure that can contain all possible traversals of a hierarchical data tree structure from the leaf nodes of the tree structure.

### SUMMARY

Some embodiments provide a system, method, device, program code and/or means for deriving from hierarchical data represented a data structure having hierarchies based on a leaf node entity. The method may include determining a reverse bridge table data structure for the hierarchical data, the reverse bridge table data structure including an association of all ancestor node entities of the hierarchical data for each leaf node entity of the hierarchical data and a hierarchical level for each association, determining an ordered listing of the associations of the ancestor node entities and each leaf node entity based on the hierarchical level for each association, and providing a hierarchy table data structure including an ordered aggregation of the hierarchical levels for each of the leaf node entities.

A system according to embodiments herein may include a memory having hierarchical data stored thereon and a processor being in communication with the memory, the processor operable to determine a reverse bridge table data structure for the hierarchical data, the reverse bridge table data structure including an association of all ancestor node entities of the hierarchical data for each leaf node entity of the hierarchical data and a hierarchical level for each association; determine an ordered listing of the associations of the ancestor node entities and each leaf node entity based on the hierarchical level for each association; and provide an output of a hierarchy table data structure including an ordered aggregation of the hierarchical levels for each of the leaf node entities.

In some embodiments, a medium having machine executable program instructions stored thereon that may be executed to implement the methods and systems disclosed herein.

With these and other advantages and features that will become hereinafter apparent, further information may be obtained by reference to the following detailed description and appended claims, and to the figures attached hereto.

### BRIEF DESCRIPTION OF THE DRAWINGS

Some embodiments are illustrated in the accompanying figures, in which like reference numerals designate like parts, and wherein:

FIG. 1 is an illustrative tree diagram relating to hierarchical data, according to some embodiments herein;

FIG. 2 is a table relating to the hierarchical data of FIG. 1;

FIG. 3 is a table illustrating a data structure, in accordance with some embodiments herein;

FIG. 4 is another table illustrating a data structure, in accordance with some embodiments herein;

FIG. 5 is a hierarchy table data structure, in accordance with some embodiments herein;

FIG. 6 is a flow diagram of a process, according to some embodiments; and

FIG. 7 is a representative block diagram of a system, according to some embodiments herein.

### DETAILED DESCRIPTION OF SPECIFIC EMBODIMENTS

FIG. 1 is an illustrative depiction of hierarchical data represented by graphical tree structure 100. Tree structure 100 has a root node entity 105 connected to end or leaf node entities 115, 120, and 130 by a number of branches. The branches (i.e., lines) connect root node entity 105, nodes 110, 125, and leaf nodes 115, 120, and 130. Typically, tree structure 100 may be described in a top down manner, based on a parent-child relation between a subject or parent node and a descendent or child of that parent node. It is noted that tree structure 100 is representative of hierarchical data herein and tree structure 100 may include more or fewer branches, nodes, and leaf nodes than those expressly depicted in the example of FIG. 1.

In some embodiments, the hierarchical data represented by tree structure 100 may be indeterminately deep, based on a parent-child relationship. Executing a query against tree structure 100 based on a top down organized hierarchical data structure based on parent-child relationships to a leaf node typically requires traversing the tree structure from the root node to the leaf node and keeping account of the parent-child relationships. Such traversals may be time consuming, resource hungry, and complex.

In accordance with some embodiments herein, the present disclosure provides a method, and mechanisms to efficiently provide, create, and build a bottom up data structure that can contain all possible traversals of a hierarchical data tree structure from the leaf nodes of the tree structure. In such a data structure provided here, the hierarchy may be represented by a bottom up paradigm having all keys and hierarchies based on the leaf nodes.

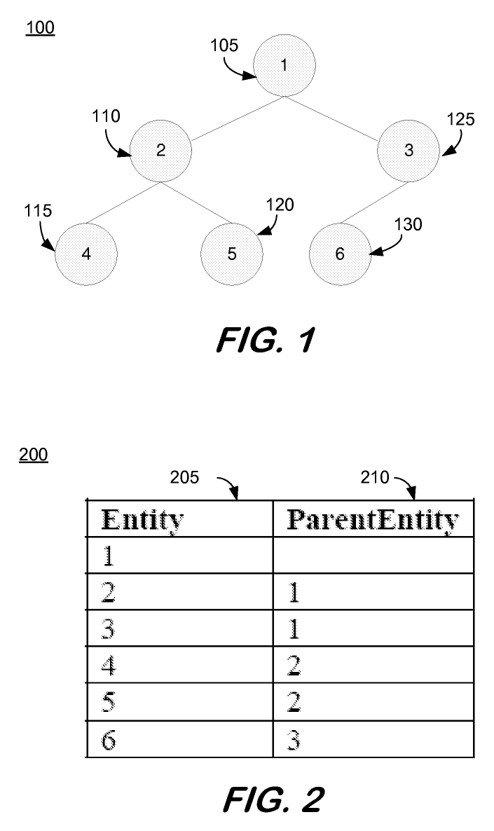

FIG. 2 is a table listing the parent-child relationship of tree structure 100. As shown, child nodes 2 (110) and 3 (125) are related to parent node 1 (105), child nodes 4 (115) and 5 (120) are related to their parent node 2 (110), and child node 6 (130) is related to its parent node 3 (123). It is noted that root node 1 (105) has no parent, and leaf nodes 4 (115), 5 (120), and 6 (130) have no children or descendents.

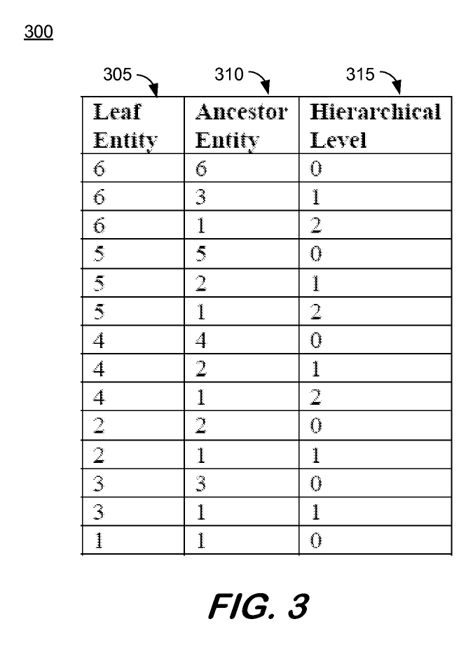

In accordance with some embodiments, a bottom up data structure may be constructed that contains all possible traversals of a hierarchical data tree structure starting from a leaf node. FIG. 3 is a table illustrating a reverse bridge table data structure 300 that expands the hierarchy for tree structure 100 such that every node becomes a “root” node and each of the ancestors of the subject “root” node is paired with the “root” node. Reverse bridge table data structure 300 may be determined by traversing tree structure 100 starting at the leaf nodes 4 (115), 5 (120), and 6 (130). Reverse bridge table data structure 300 lists each node in column 305 and all of the ancestors paired therewith in column 310 such that each leaf-ancestor node pairing is listed on a row of the reverse bridge table data structure.

Reverse bridge table data structure 300 further includes a listing of a hierarchical level (315), including a hierarchical level value for each of the leaf-ancestor node pairings. The value of the hierarchical level 315 for each leaf-ancestor node pairing may be determined by computing the number of levels between the subject leaf (root) node and the associated ancestor. For example, there are no intervening levels between node 6 (or any other node) and itself. The number of levels between node 6 and ancestor 3 is one, and the number of levels between node 6 and 1 is two.

In some embodiments, the hierarchical levels for a reverse bridge table data structure may be inverted or reversed to provide an ordered listing of the reverse bridge table data structure based on the hierarchical levels of the leaf-ancestor node pairings. The value for the reversed hierarchical levels may be calculated using the following:

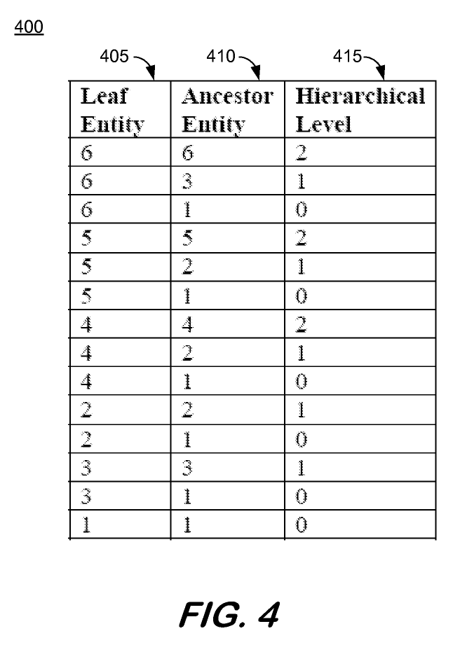

RHierarchicalLevel=ABS(HierarchicalLevel−@MaxLevel)

where @MaxLevel=Max (Set of Possible HierarchicalLevel); HierarchicalLevel=number of levels between each leaf node entity and an associated ancestor node entity; and RHierarchicalLevel=the reverse or inverted hierarchical level value. As illustrated in FIG. 4, there is shown a reverse bridge table data structure 400 where the hierarchical levels 415 have been adjusted and provided in the ordered configuration shown. Data structure 400 including the ordered listing of the reverse bridge table data structure based on the hierarchical levels of the leaf-ancestor node pairings may be used to provide a bottom up aggregation when positioned at a leaf node of the hierarchical data.

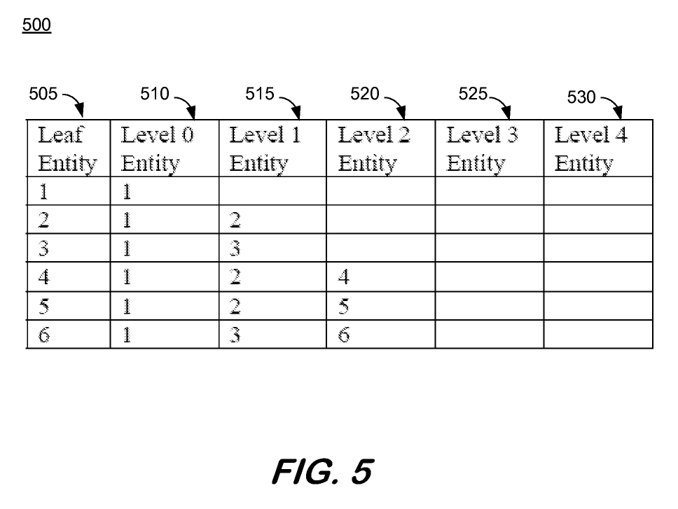

A “pivot operation” may be performed on data structure 400 to create a data structure that contains the entire hierarchy for a given leaf node in one row. FIG. 5 provides a pivoted hierarchy data structure 500 resulting from performing a “pivot operation” on data structure 400. Pivoted hierarchy data structure 500 includes a single listing of each node entity in column 505 and a listing for all of the ancestor nodes of each node in the same row as a given node entity. The ancestor nodes are arranged according to the hierarchical level of each ancestor node listed in data structure 400. In this manner, pivoted hierarchy data structure 500 may provide an aggregation or summary of the hierarchical levels for each node in one row. Referring to pivoted hierarchy data structure 500, the hierarchical level is provided in columns 510 (level 0), 515 (level 1), 520 (level 2), 525 (level 3), and 530 (level 4); the leaf values are the keys; and each ancestor node is an element of the record.

In some embodiments, the creation of pivoted hierarchy data structure 500 for a record or set of hierarchical data may be used to efficiently query the hierarchical data by allowing a tree traversal to occur with a minimal amount of computing resources, time, and complexity since pivoted hierarchy data structure 500 provides an aggregation or summary of the hierarchical levels for each leaf node. Further, executing a query against hierarchical data represented by a pivoted hierarchy data structure may facilitate the generation of leaf-centric reports against an indeterminately deep data hierarchy.

In some embodiments, the queries of the indeterminately deep data hierarchy may be implemented using an application, service, or a database programming language such as SQL (Structured Query Language) to query and retrieve the hierarchical data from, for example, a database. In some embodiments, the application, service, or a database programming language may be used to implement all or at least portions of the data structures disclosed herein.

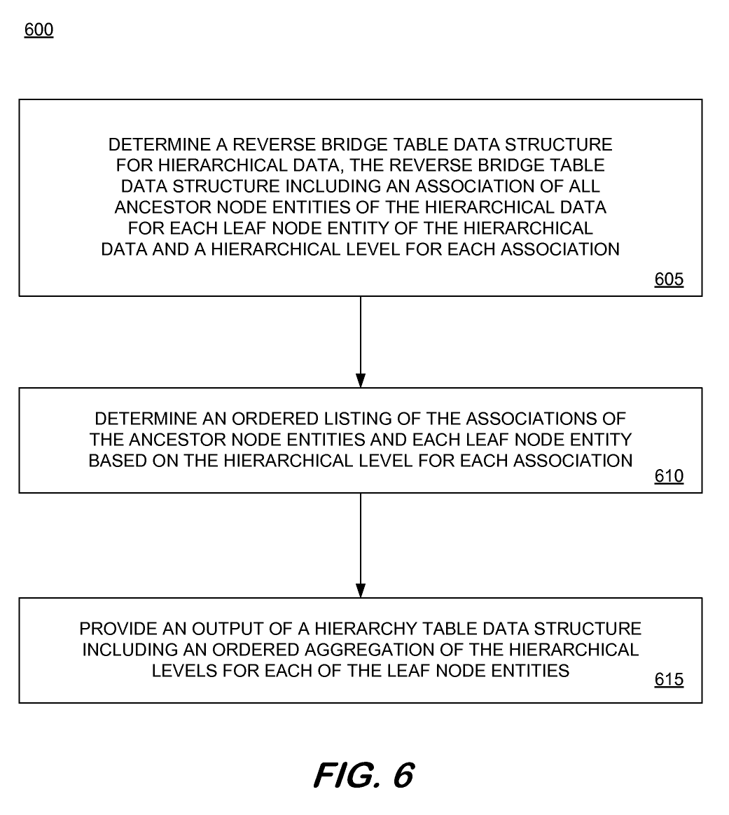

FIG. 6 is an illustrative depiction of an overall flow diagram of a process 600 for deriving from hierarchical data a data structure having hierarchies based on a leaf node entity, in accordance with an embodiment herein. At operation 605, a reverse bridge table data structure (e.g., 300) for the hierarchical data is determined. The reverse bridge table data structure may include an association of all ancestor node entities of the hierarchical data for each leaf node entity of the hierarchical data and a hierarchical level for each association.

At operation 610, an ordered listing of the associations of the ancestor node entities and each leaf node entity based on the hierarchical level for each association (e.g., 400) is determined. At operation 615, a hierarchy table data structure (e.g., 500) including an ordered aggregation of the hierarchical levels for each of the leaf node entities is provided.

In some embodiments, flow diagram 600 may further include additional, fewer, substitute, and modified processes in addition to or in place of those specifically shown in FIG. 6. For example, process 600 may include an initial step of requesting a report on the hierarchical data or a query performed against the hierarchical data. In some instances, process 600 may include a step of generating a report regarding a data retrieval or query against the hierarchical data that uses the data structures created by the operations shown in FIG. 6. It is further noted that the operations of process 600 may be altered from those specifically shown in FIG. 6.

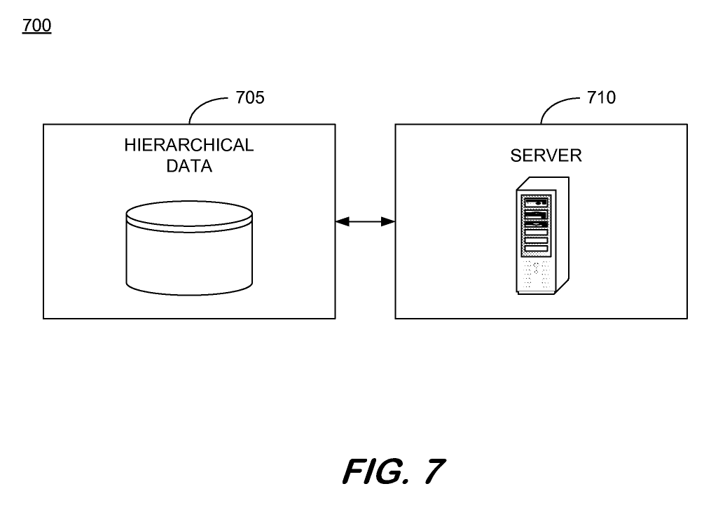

FIG. 7 is an illustrative block diagram of system 700 according to some embodiments herein. System 700 may be provided to facilitate provisioning a data structure for reporting on hierarchical data, including reporting on indeterminately deep hierarchies. System 700 includes a memory 705 in communication with a processor 710. In the example of system 700, memory 705 may be any device, apparatus, or system capable of storing data or a persistence of data. Memory 705 may include a hard disk drive, solid state memory devices, cache, ROM, RAM, a database, and any other type of data storage mechanism capable of storing data, including but not limited to hierarchical data.

Processor 710 may include, for example, an apparatus, device, system, or subsystem including a processor for executing and/or supporting code, programs, applications, and services to implement the various methods and embodiments disclosed herein. In some embodiments, processor 710 may form part of an application server, server, database server, PC, laptop, netbook, mobile telephone, smartphone, and other computing machines and devices. As shown, processor 710 may be in communication with memory 705. The communication link between memory 705 and processor 710 may be temporary, permanent, ad-hoc, static, dynamic, wired, wireless, and combinations thereof. The particular communication protocol used to communicate messages, commands, information, data, etc. between memory 705 and processor 710 may vary without limit to a particular format, structure, or design in accordance with the other aspects of the present disclosure.

In some embodiments, system 700 may be a dedicated system for facilitating the methods disclosed herein. In some embodiments, system 700 may include components capable of general computing processing and/or data storage and retrieval.

In some embodiments, the methods and systems disclosed herein may be implemented by a hardware only embodiment, a software only embodiment, and in some instances a combination of hardware and software components. In some aspects, the methods and systems may be accomplished, at least in part, using computing processors to execute computer code and program instructions stored on a memory (e.g., flash memory, RAM, ROM, disk drive, and other media) or otherwise accessible by the processor.

Embodiments described above are not intended to be limited to the specific form set forth herein, but are intended to cover such alternatives, modifications and equivalents as can reasonably be included within the spirit and scope of the appended claims.

What is claimed is:

1. A computer-implemented method for deriving from hierarchical data a data structure having hierarchies based on a leaf node entity, the method comprising:
determining a reverse bridge table data structure for the hierarchical data, the reverse bridge table data structure including an association of all ancestor node entities of the hierarchical data for each leaf node entity of the hierarchical data and a hierarchical level for each association;
determining an ordered listing of the associations of the ancestor node entities and each leaf node entity based on the hierarchical level for each association; and
providing a hierarchy table data structure including an ordered aggregation of the hierarchical levels for each of the leaf node entities.

2. The method of claim 1, wherein the association of all of the ancestor node entities of the hierarchical data for each leaf node entity of the hierarchical data includes all of the possible traversals of the hierarchical data.

3. The method of claim 1, further comprising calculating the hierarchical level for each of the associations of the ancestor node entities and each leaf node entity.

4. The method of claim 3, wherein the hierarchical level is calculated by determining a number of levels between each leaf node entity and an associated ancestor node entity.

5. The method of claim 1, wherein the determining of the ordered listing of the associations of the ancestor node entities and each leaf node entity based on the hierarchical level for each association includes determining a reversal of the hierarchical levels for each of the associations.

6. The method of claim 5, wherein the reversal of the hierarchical levels for each of the associations is calculated based on the following equations for each leaf node entity:
RHierarchicalLevel=ABS(HierarchicalLevel−@MaxLevel)
where @MaxLevel=Max (Set of Possible HierarchicalLevel);
HierarchicalLevel=number of levels between each leaf node entity and an associated ancestor node entity; and RHierarchicalLevel=the reverse or inverted hierarchical level value.

7. The method of claim 1, further comprising:
executing a query against the hierarchy table data structure including the ordered aggregation of the hierarchical levels for each of the leaf node entities; and
generating a reporting of the query results.

8. A system for deriving from hierarchical data a data structure having hierarchies based on a leaf node entity, the system comprising:
a memory having hierarchical data stored thereon; and
a processor in communication with the memory, the processor operable to:
determine a reverse bridge table data structure for the hierarchical data, the reverse bridge table data structure including an association of all ancestor node entities of the hierarchical data for each leaf node entity of the hierarchical data and a hierarchical level for each association;
determine an ordered listing of the associations of the ancestor node entities and each leaf node entity based on the hierarchical level for each association; and
provide an output of a hierarchy table data structure including an ordered aggregation of the hierarchical levels for each of the leaf node entities.

9. The system of claim 8, wherein the association of all of the ancestor node entities of the hierarchical data for each leaf node entity of the hierarchical data includes all of the possible traversals of the hierarchical data.

10. The system of claim 8, further comprising calculating the hierarchical level for each of the associations of the ancestor node entities and each leaf node entity.

11. The system of claim 10, wherein the hierarchical level is calculated by determining a number of levels between each leaf node entity and an associated ancestor node entity.

12. The system of claim 8, wherein the determining of the ordered listing of the associations of the ancestor node entities and each leaf node entity based on the hierarchical level for each association includes determining a reversal of the hierarchical levels for each of the associations.

13. The system of claim 12, wherein the reversal of the hierarchical levels for each of the associations is calculated based on the following equations for each leaf node entity:
RHierarchicalLevel=ABS(HierarchicalLevel−@MaxLevel)
where @MaxLevel=Max (Set of Possible HierarchicalLevel);
HierarchicalLevel=number of levels between each leaf node entity and an associated ancestor node entity; and RHierarchicalLevel=the reverse or inverted hierarchical level value.

14. A medium having machine readable program instructions stored thereon for deriving from hierarchical data a data structure having hierarchies based on a leaf node entity, the instructions comprising:
instructions to determine a reverse bridge table data structure for the hierarchical data, the reverse bridge table data structure including an association of all ancestor node entities of the hierarchical data for each leaf node entity of the hierarchical data and a hierarchical level for each association;
instructions to determine an ordered listing of the associations of the ancestor node entities and each leaf node entity based on the hierarchical level for each association; and
instructions to provide an output of a hierarchy table data structure including an ordered aggregation of the hierarchical levels for each of the leaf node entities.

15. The medium of claim 14, wherein the association of all of the ancestor node entities of the hierarchical data for each leaf node entity of the hierarchical data includes all of the possible traversals of the hierarchical data.

16. The medium of claim 14, further comprising calculating the hierarchical level for each of the associations of the ancestor node entities and each leaf node entity.

17. The medium of claim 16, wherein the hierarchical level is calculated by determining a number of levels between each leaf node entity and an associated ancestor node entity.

18. The medium of claim 14, wherein the determining of the ordered listing of the associations of the ancestor node entities and each leaf node entity based on the hierarchical level for each association includes determining a reversal of the hierarchical levels for each of the associations.

19. The medium of claim 18, wherein the reversal of the hierarchical levels for each of the associations is calculated based on the following equations for each leaf node entity:
RHierarchicalLevel=ABS(HierarchicalLevel−@MaxLevel)
where @MaxLevel=Max (Set of Possible HierarchicalLevel);
HierarchicalLevel=number of levels between each leaf node entity and an associated ancestor node entity; and RHierarchicalLevel=the reverse or inverted hierarchical level value.
